(19) United States
(12) Patent Application Publication
(10) Pub. No.: US 2024/0360002 A1
(43) Pub. Date: Oct. 31, 2024

(54) HIGH-VALENT DOPED LITHIUM- AND MANGANESE-RICH POSITIVE ELECTRODE MATERIALS AND METHODS OF MANUFACTURING THE SAME

(71) Applicant: GM GLOBAL TECHNOLOGY OPERATIONS LLC, Detroit, MI (US)

(72) Inventors: Devendrasinh DARBAR, Sterling Heights, MI (US); Raneen Taha, Sterling Heights, MI (US); Gongshin Qi, Troy, MI (US)

(21) Appl. No.: 18/306,900

(22) Filed: Apr. 25, 2023

(51) Int. Cl. C01G 53/00

(52) U.S. Cl. CPC C01G 53/50; C01G 53/006; C01P 2004/90; C01P 2006/40

(57) ABSTRACT

A positive electrode material for an electrochemical cell that cycles lithium ions includes a high-valent doped layered lithium- and manganese-rich nickel oxide (HVD-LMR). The high-valent dopant is a transition metal element having five or more valence electrons. The HVD-LMR positive electrode material may be manufactured by a sol-gel method, wherein a precursor solution is prepared comprising a lithium salt, a manganese salt, a nickel salt, a compound comprising the high-valent dopant, and a chelating agent. The pH of the precursor solution is controlled or adjusted to form a gel comprising a liquid phase and a solid precipitate phase, and then the liquid phase from the solid precipitate phase to form a dried gel. The dried gel is heated in an oxygen-containing environment to form the HVD-LMR positive electrode material.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to positive electrode materials for electrochemical cells that cycle lithium ions, and more particularly to positive electrode materials including high-valent doped lithium- and manganese-rich oxides.

Layered lithium and manganese-rich oxides (LMR) are attractive candidates for positive electrode materials of electrochemical cells that cycle lithium ions due to their relatively high capacity (e.g., >250 mAh/g), thermal stability, and relatively low cost. However, LMR has been found to exhibit voltage decay, low coulombic efficiency, and irreversible capacity loss after repeated charge and discharge cycles. One proposed mechanism for the observed performance degradation is due to the oxidation of oxygen anions in the LMR crystal lattice during electrochemical charging and the associated release and irreversible loss of molecular oxygen therefrom. In turn, the loss of oxygen from the LMR crystal lattice may promote the migration of transition metal ions within the LMR, leading to an irreversible phase transition from a layered structure to a spinel or spinel-like structure. This layered-to-spinel phase transformation has been found to be detrimental to the electrochemical performance of lithium batteries and may be attributed to the relatively lithium-poor nature of the spinel phase and because the presence of spinel phases within the layered crystal structure of the LMR impedes the diffusion of lithium ions during cycling.

It would be desirable to develop layered lithium and manganese-rich oxide materials with increased resistance to irreversible oxygen redox reactions and to phase transformations during cycling, particularly at high voltages.

### SUMMARY

A positive electrode material for an electrochemical cell that cycles lithium ions is disclosed. The positive electrode material comprises a layered lithium- and manganese-rich oxide represented by the formula (1):

Li₁₊ₐNi_{b}Mn_{c}Me_{d}O₂, (1)

where the value of a is greater than or equal to about 0.1 and less than or equal to about 0.3, b is greater than or equal to about 0.1 and less than or equal to about 0.5, c is greater than or equal to about 0.4 and less than or equal to about 0.7, d is greater than or equal to about 0.002 and less than or equal to about 0.04, and Me represents a transition metal having five or more valence electrons.

The transition metal having five or more valence electrons (Me) may be hexavalent molybdenum Mo(VI), hexavalent tungsten W(VI), pentavalent niobium Nb(V), or a combination thereof.

In aspects, a may be greater than or equal to about 0.15 and less than or equal to about 0.25, b may be greater than or equal to about 0.2 and less than or equal to about 0.3, c may be greater than or equal to about 0.5 and less than or equal to about 0.6, and d may be greater than or equal to about 0.005 and less than or equal to about 0.025.

A ratio of (1+a) to (b+c+d) may be greater than or equal to 1.4 and less than or equal to 1.7.

A ratio of c to b may be greater than or equal to 1 and less than or equal to 5.

The oxide may have a layered crystal structure including a transition metal layer, an oxygen layer, and a lithium layer. In such case, the transition metal having five or more valence electrons may be present at an octahedral site within the transition metal layer.

A method of manufacturing a positive electrode material for an electrochemical cell that cycles lithium ions is disclosed. The method includes steps (a)-(d). Step (a) includes preparing a precursor solution comprising a lithium salt, a manganese salt, a nickel salt, a compound comprising a transition metal having five or more valence electrons, and a chelating agent in a solvent. Step (b) includes controlling or adjusting a pH of the precursor solution to form a gel comprising a liquid phase and a solid precipitate phase. Step (c) includes removing the liquid phase from the solid precipitate phase to form a dried gel. Step (d) includes heating the dried gel in an oxygen-containing environment to form a layered lithium- and manganese-rich oxide represented by the formula (1):

Li₁₊ₐNi_{b}Mn_{c}Me_{d}O₂, (1)

where the value of a is greater than or equal to about 0.1 and less than or equal to about 0.3, b is greater than or equal to about 0.1 and less than or equal to about 0.5, c is greater than or equal to about 0.4 and less than or equal to about 0.7, d is greater than or equal to about 0.002 and less than or equal to about 0.04, and Me represents a transition metal having five or more valence electrons.

The transition metal having five or more valence electrons may comprise hexavalent molybdenum Mo(VI), hexavalent tungsten W(VI), pentavalent niobium Nb(V), or a combination thereof.

The lithium salt, the manganese salt, and the nickel salt may comprise carbonates, nitrates, sulfates, hydroxides, acetates, or a combination thereof.

The lithium salt may comprise lithium acetate, the manganese salt comprises manganese acetate, and the nickel salt comprises nickel acetate.

The compound comprising the transition metal having five or more valence electrons may comprise an ammonium compound, a hydrate, an oxalate, an oxide, a nitrate, or a combination thereof.

The chelating agent may comprise citric acid.

The solvent may comprise water.

Controlling or adjusting the pH of the precursor solution in step (b) may comprise introducing a base into the precursor solution such that the precursor solution has a pH of about 7.

The precursor solution may comprise a stoichiometric excess of lithium. In such case, a molar ratio of lithium to the combined amount of manganese, nickel, and the transition metal having five or more valence electrons [Li/(Mn+Ni+Me)] in the precursor solution may be greater than or equal to 1.4 and less than or equal to 1.7.

A molar ratio of Mn to Ni in the precursor solution may be greater than or equal to 1 and less than or equal to 5.

Step (c) may comprise heating the gel at a temperature in a range of 100 degrees Celsius to 200 degrees Celsius such that gaseous reaction products of H₂O and/or NH₃ are released therefrom.

Step (d) may comprise heating the dried gel at a temperature in a range of 400 degrees Celsius to 600 degrees Celsius to form a powder having an amorphous structure, and then calcining the powder by heating the powder in an oxygen-containing environment at a temperature of about 700 degrees Celsius to about 1000 degrees Celsius to form the layered lithium- and manganese-rich oxide represented by the formula (1).

After the powder is calcined, the layered lithium- and manganese-rich oxide represented by the formula (1) may have a layered crystal structure including a transition metal layer, an oxygen layer, and a lithium layer. In such case, the transition metal having five or more valence electrons may be present at an octahedral site within the transition metal layer.

The method may further comprise mixing particles of the layered lithium- and manganese-rich oxide represented by the formula (1) with particles of an electrically conductive material and a polymer binder.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic cross-sectional view of an electrochemical cell that cycles lithium ions, the electrochemical cell comprises a positive electrode, a negative electrode, a porous separator, and an electrolyte.

FIG. 2 is a schematic diagram of a method for forming a high-valent doped lithium- and manganese-rich nickel oxide (HVD-LMR) via a sol-gel process.

FIG. 3 is a plot of Normalized Intensity vs. the Angle (2Θ_{CuKα}) depicting X-ray diffraction patterns for samples of HVD-LMR and undoped-LMR.

FIG. 4 is a plot of Potential vs. Li/Li⁺ versus Specific Capacity depicting charging voltages and discharging voltages for the first formation cycle of samples of HVD-LMR and undoped-LMR.

In the drawings, reference numbers may be reused to identify similar and/or identical elements.

### DETAILED DESCRIPTION

A positive electrode material according to the present disclosure comprises a layered lithium- and manganese-rich nickel oxide (LMR) that has been doped with a high-valent dopant (HVD), i.e., a transition metal having five or more valence electrons. Electrochemical cells including the presently disclosed HVD-LMR positive electrode materials have been found to exhibit improved electrochemical performance. For example, as compared to electrochemical cells in which undoped LMR is used as the positive electrode material, the presently disclosed HVD-LMR positive electrode materials have been found to exhibit substantially higher coulombic efficiencies and higher specific capacities. Without intending to be bound by theory, it is believed that, due to the higher HVD-oxygen bond dissociation energies (as compared to the manganese-oxygen (Mn—O) and nickel-oxygen (Ni—O) bond dissociation energies), the HVD may help prevent irreversible oxygen loss and/or increase the probability that oxygen ions will return to octahedral positions within the HVD-LMR crystal lattice during cycling.

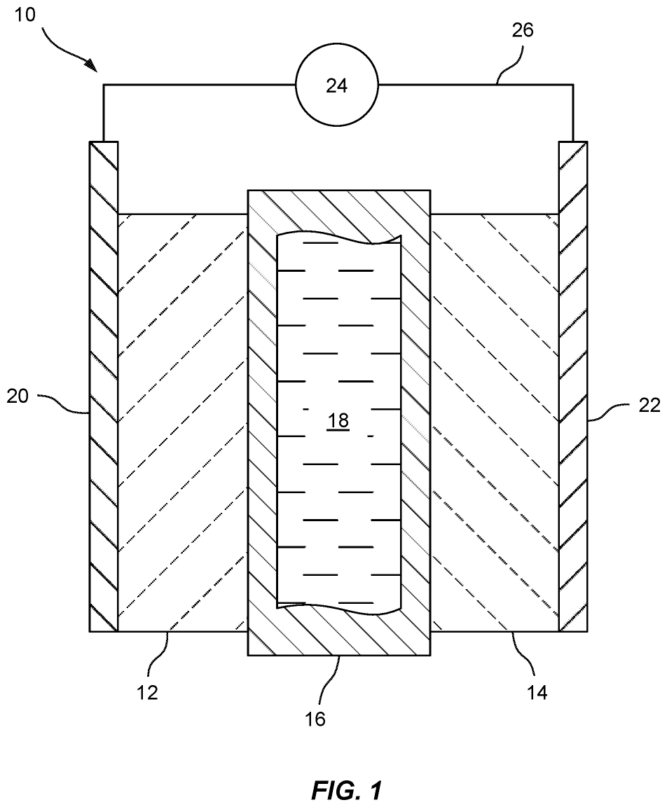

FIG. 1, depicts a schematic side cross-sectional view of an electrochemical cell 10 that cycles lithium ions. The electrochemical cell 10 comprises a positive electrode 12, a negative electrode 14, a separator 16, and an electrolyte 18. The positive electrode 12 is disposed on a major surface of a positive electrode current collector 20 and the negative electrode 14 is disposed on a major surface of a negative electrode current collector 22. In practice, the positive and negative electrode current collectors 20, 22 may be electrically coupled to a power source or load 24 via an external circuit 26.

The electrochemical cell 10 may be used in secondary lithium batteries for vehicle or automotive transportation applications (e.g., motorcycles, boats, tractors, buses, motorcycles, mobile homes, campers, and tanks), as well as in a wide variety of other industries and applications, including aerospace components, consumer products, devices, buildings (e.g., houses, offices, sheds, and warehouses), office equipment and furniture, and industrial equipment machinery, agricultural or farm equipment, or heavy machinery, by way of non-limiting example. In certain aspects, the electrochemical cell 10 may be used in secondary lithium batteries for hybrid electric vehicles (HEVs) and/or electric vehicles (EVs).

The positive electrode 12 is configured to store and release lithium ions during discharge and charge of the electrochemical cell 10 and may be in the form of a continuous porous layer disposed on the major surface of the positive electrode current collector 20. The positive electrode 12 includes at least one electrochemically active (electroactive) material that can facilitate the storage and release of lithium ions by undergoing a reversible redox reaction with lithium. At least one of the electroactive materials of the positive electrode 12 comprises a layered lithium- and manganese-rich nickel oxide that has been doped with a high-valent transition metal dopant (HVD-LMR). The HVD-LMR electroactive material of the positive electrode 12 is represented by the formula (1):

Li₁₊ₐNi_{b}Mn_{c}Me_{d}O₂, (1)

where 0.1≤a≤0.3, 0.1≤b≤0.5, 0.4≤c≤0.7, 0.002≤d≤0.04, a+b+c+d=1, and Me represents a high-valent dopant (HVD), i.e., a transition metal having five or more valence electrons. The HVD-LMR electroactive material of formula (1) comprises a stoichiometric excess of lithium. As such, in aspects, a may be greater than or equal to about 0.1, or optionally about 0.15, and less than or equal to about 0.3, optionally about 0.25, or optionally about 0.2. In aspects, b may be greater than or equal to about 0.1, or optionally about 0.2, and less than or equal to about 0.5, or optionally about 0.3; c may be greater than or equal to about 0.4, or optionally about 0.5, and less than or equal to about 0.7, or optionally about 0.6; and d may be greater than or equal to about 0.002, or optionally about 0.005, and less than or equal to about 0.04, optionally about 0.03, optionally about 0.025, or optionally about 0.02. Additionally or alternatively, a ratio of (1+a) to (b+c+d), i.e., (1+a)/(b+c+d), may be 1.4 to 1.7. For example, a ratio of (1+a)/(b+c+d) of 1.4 to 1.7 encompasses a (1+a):(b+c+d) ratio of 1.4:1, 1.5:1, 1.6:1, 1.7:1, etc. Additionally or alternatively, a ratio of c to b (c/b) may be 1 to 5. For example, a ratio of c/b of 1 to 5 encompasses a c:b ratio of 1:1, 2:1, 3:1, 4:1, 5:1, etc. Me can represent a transition metal having five valence electrons (a pentavalent transition metal), a transition metal having six valence electrons (a hexavalent transition metal), a transition metal having seven valence electrons (a heptavalent transition metal), or a combination thereof. Examples of high-valent transition metals having five or more valence electrons include hexavalent molybdenum Mo(VI), hexavalent tungsten W(VI), pentavalent niobium Nb(V), and combinations thereof. In one form, the HVD-LMR electroactive material of formula (1) may be doped with Mo(VI) and may comprise Li₁₊ₐNi_{b}Mn_{c}Me_{d}O₂. In another form, the HVD-LMR electroactive material of formula (1) may be doped with W(VI) and may comprise Li₁₊ₐNi_{b}Mn_{c}W_{d}O₂. In yet another form, the HVD-LMR electroactive material of formula (1) may be doped with Nb(V) and may comprise Li₁₊ₐNi_{b}Mn_{c}Nb_{d}O₂.

The HVD-LMR electroactive material of formula (1) may have a layered (monoclinic) crystal structure with a repeating transition metal (TM) layer, oxygen layer, and lithium (Li) layer. The TM layer comprises the Mn and Ni. Because the HVD-LMR electroactive material of formula (1) comprises a stoichiometric excess of lithium, the TM layer also may comprise Li. The HVD is present within the layered crystal structure of the HVD-LMR electroactive material of formula (1). For example, when the HVD-LMR electroactive material of formula (1) has a layered crystal structure, the HVD may be present at octahedral sites within the TM layer. In other words, the HVD-LMR electroactive material of formula (1) may be substitutionally doped with the HVD, with the HVD replacing a Mn ion or an Ni ion in the TM layer. When the HVD-LMR electroactive material of formula (1) has a layered (monoclinic) crystal structure, the Mn, Ni, and HVD ions present at octahedral sites within the TM layer are necessarily coordinated and bonded to six (6) oxygen atoms. When octahedrally coordinated with oxygen, the bond dissociation energy of the manganese-oxygen (Mn—O) bond is about 402 kilojoules per mole (kJ/mol) and the bond dissociation energy of the nickel-oxygen (Ni—O) bond is about 392 kJ/mol. On the other hand, when octahedrally coordinated with oxygen, the bond dissociation energy of the hexavalent molybdenum-oxygen (Mo—O) bond is about 607 kJ/mol, the bond dissociation energy of the hexavalent tungsten-oxygen (W—O) bond is about 653 kJ/mol, and the bond dissociation energy of the pentavalent niobium-oxygen (Nb—O) bond is about 753 kJ/mol. Due to the relatively high HDV—O bond dissociation energies (as compared to the Mn—O and Ni—O bond dissociation energies), it is believed that, in the HVD-LMR electroactive material of formula (1), the affinity and/or oxygen bond strength between the HVD and oxygen is greater than the affinity and/or oxygen bond strength between Mn—O and Ni—O. As a result of the higher bond strength between the HDV and oxygen, it is believed that doping LMR with a HVD can help prevent irreversible oxygen loss and/or increase the probability that oxygen ions will return to octahedral positions within the HVD-LMR crystal lattice during cycling, which in turn prevent undesirable irreversible phase transformations and thereby improve the coulombic efficiency and specific capacity of the electrochemical cell 10, as compared to electrochemical cells in which undoped LMR is used as the positive electrode material.

In aspects, the HVD-LMR electroactive material of formula (1) may be in particle form. In such case, particles of the HVD-LMR electroactive material of formula (1) may be substantially spherical and may have aspect ratios close to one (1). For example, particles of the HVD-LMR electroactive material of formula (1) may be substantially spherical and may have aspect ratios of less than 10. Particles of the HVD-LMR electroactive material of formula (1) may have a mean particle diameter of greater than or equal to about 10 nanometers and less than or equal to about 500 nanometers.

The HVD-LMR electroactive material of formula (1) may be present in the positive electrode 12 in an amount, by weight, greater than or equal to about 30 wt. %, greater than or equal to about 40 wt. %, greater than or equal to about 50 wt. %, greater than or equal to about 60 wt. %, greater than or equal to about 70 wt. %, greater than or equal to about 80 wt. %, greater than or equal to about 90 wt. %, greater than or equal to about 96 wt. %, or about 98 wt. %; or from about 30 wt. % to about 98 wt. %, about 40 wt. % to about 98 wt. %, about 40 wt. % to about 96 wt. %, about 40 wt. % to about 90 wt. %, about 40 wt. % to about 80 wt. %, about 40 wt. % to about 70 wt. %, about 40 wt. % to about 60 wt. %, or about 40 wt. % to about 50 wt. %.

The electroactive material of the positive electrode 12 may comprise, in addition to the HVD-LMR electroactive material of formula (1), a material that can undergo lithium intercalation and deintercalation or can undergo a conversion by reaction with lithium. In aspects, the electroactive material of the positive electrode 12 may comprise an intercalation host material that can undergo the reversible insertion or intercalation of lithium ions. In such case, the electroactive material of the positive electrode 12 may comprise a layered oxide represented by the formula LiMeO₂ and/or Li₂MeO₃, an olivine-type oxide represented by the formula LiMePO₄, a monoclinic-type oxide represented by the formula Li₃Me₂(PO₄)₃, a spinel-type oxide represented by the formula LiMe₂O₄, a tavorite represented by one or both of the following formulas LiMeSO₄F or LiMePO₄F, or a combination thereof, where Me is a transition metal (e.g., Co, Ni, Mn, Fe, Cr, Al, V, or a combination thereof). In aspects, the electroactive material of the positive electrode 12 may comprise spinel lithium manganese oxide (LiMn₂O₄, LMO), layered lithium-manganese-rich oxide (Li₂MnO₃, LMR), high voltage spinel (LiNi_{0.5}Mn_{1.5}O₄, LNMO), lithium nickel manganese cobalt (LiNiₓMn_{y}Co_{z}O₂, NMC), lithium nickel cobalt manganese aluminum oxide (LiNiₐCo_{b}Mn_{c}Al_{d}O₂, NCMA), lithium nickel manganese aluminum oxide (LiNiₓMn_{y}Al_{z}O₂, where 0.8x≥1, 0≤y0.2, 0≤z0.2, and x+y+z=1) lithium nickel iron aluminum oxide (LiNiₓFe_{y}Al_{z}O₂, where 0.8x≥1, 0≤y0.2, 0≤z0.2, and x+y+z=1) and combinations thereof. In aspects, the electroactive material of the positive electrode 12 may be substantially free of cobalt (Co).

The electroactive material of the positive electrode 12 may be a particulate material and particles of the electroactive material of the positive electrode 12 may be intermingled with a polymer binder, for example, to provide the positive electrode 12 with structural integrity. Examples of polymer binders include polyvinylidene fluoride (PVDF), polytetrafluoroethylene (PTFE), ethylene propylene diene monomer (EPDM) rubber, styrene butadiene rubber (SBR), carboxymethyl cellulose (CMC), nitrile butadiene rubber (NBR), styrene-butadiene rubber (SBR), styrene ethylene butylene styrene copolymer (SEBS), polyacrylates, alginates, polyacrylic acid, and combinations thereof. In aspects, the positive electrode 12 may comprise a polymer binder comprising polyvinylidene fluoride.

The positive electrode 12 optionally may include particles of an electrically conductive material. Examples of electrically conductive materials include carbon-based materials, metals (e.g., nickel), and/or electrically conductive polymers. Examples of electrically conductive carbon-based materials include carbon black (CB) (e.g., acetylene black), graphite, graphene (e.g., graphene nanoplatelets, GNP), graphene oxide, carbon nanotubes (CNT), and/or carbon fibers (e.g., carbon nanofibers). Examples of electrically conductive polymers include polyaniline, polythiophene, polyacetylene, and/or polypyrrole. In aspects, the electrically conductive material of the positive electrode 12 may comprise carbon black.

The negative electrode 14 is configured to store and release lithium ions during charge and discharge of the electrochemical cell 10 and may be in the form of a continuous porous or nonporous layer of material disposed on a major surface of the negative electrode current collector 24. The negative electrode 14 includes one or more electroactive materials that can facilitate the storage and release of lithium ions by undergoing a reversible redox reaction with lithium at a lower electrochemical potential than the electroactive material of the positive electrode 12 such that an electrochemical potential difference exists between the positive and negative electrodes 12, 14. Examples of electroactive materials for the negative electrode 14 include lithium, lithium-based materials, lithium alloys (e.g., alloys of lithium and silicon, aluminum, indium, tin, or a combination thereof), carbon-based materials (e.g., graphite, activated carbon, carbon black, hard carbon, soft carbon, and/or graphene), silicon, silicon-based materials (e.g., alloys if silicon and tin, iron, aluminum, cobalt, or a combination thereof and/or composites of silicon and/or silicon oxide and carbon), tin oxide, aluminum, indium, zinc, germanium, silicon oxide, lithium silicon oxide, lithium silicide, titanium oxide, lithium titanate, and combinations thereof. In some aspects, the negative electrode 22 may be in the form of a nonporous metal film or foil, such as a lithium metal film or lithium-containing foil. In other aspects, the electroactive material of the negative electrode 14 may be a particulate material and particles of the electroactive material of the negative electrode 14 may be intermingled with a polymer binder and/or particles of an electrically conductive material. The same polymer binders and/or electrically conductive materials disclosed above with respect to the positive electrode 12 may be used in the negative electrode 14.

The separator 16 physically separates and electrically isolates the positive and negative electrodes 12, 14 from each other while permitting lithium ions to pass therethrough. The separator 16 exhibits an open microporous structure and may comprise an organic and/or inorganic material that can physically separate and electrically insulate the positive and negative electrodes 12, 14 from each other while permitting the free flow of ions therebetween. For example, the separator 16 may comprise a non-woven material, e.g., a manufactured sheet, web, or mat of directionally or randomly oriented fibers. As another example, the separator 16 may comprise a microporous membrane or film. The non-woven material and/or the microporous membrane of the separator 16 may comprise a polymeric material. For example, the separator 16 may comprise a polyolefin-based material having the general formula (CH₂CH_{R})ₙ, where R is an alkyl group. In aspects, the separator 16 may comprise a single polyolefin or a combination of polyolefins. Examples of polyolefins include polyethylene (PE), polypropylene (PP), polyamide (PA), poly(tetrafluoroethylene) (PTFE), polyvinylidene fluoride (PVdF), poly(vinyl chloride) (PVC), and/or polyacetylene. Examples of other polymeric materials that may be included in or used to form the separator 16 include cellulose, polyimide, copolymers of polyolefins and polyimides, poly(lithium 4-styrenesulfonate)-coated polyethylene, polyetherimide (PEI), bisphenol-acetone diphthalic anhydride (BPADA), para-phenylenediamine, poly(m-phenylene isophthalamide) (PMIA), and/or expanded polytetrafluoroethylene reinforced polyvinylidenefluoride-hexafluoropropylene.

The electrolyte 18 provides a medium for the conduction of lithium ions through the electrochemical cell 10 between the positive and negative electrodes 12, 14 and may be in solid, liquid, or gel form. In aspects, the electrolyte 18 may comprise a non-aqueous liquid electrolyte solution including a lithium salt dissolved in a non-aqueous aprotic organic solvent or a mixture of non-aqueous aprotic organic solvents. Non-limiting examples of lithium salts include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFl), lithium (triethylene glycol dimethyl ether)bis(trifluoromethanesulfonyl)imide (Li(G₃)(TFSI), lithium bis(trifluoromethanesulfonyl)azanide (LiTFSA), and combinations thereof. Non-limiting examples of non-aqueous aprotic organic solvents include cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxyethane), cyclic ethers (e.g., tetrahydrofuran, 2-methyltetrahydrofuran), 1,3-dioxolane).

The positive and negative electrode current collectors 20, 22 are electrically conductive and provide an electrical connection between the external circuit 26 and their respective positive and negative electrodes 12, 14. In aspects, the positive and negative electrode current collectors 20, 22 may be in the form of nonporous metal foils, perforated metal foils, porous metal meshes, or a combination thereof. The negative electrode current collector 22 may be made of copper, nickel, or alloys thereof, stainless steel, or other appropriate electrically conductive material. The positive electrode current collector 20 may be made of aluminum (Al) or another appropriate electrically conductive material.

### Methods

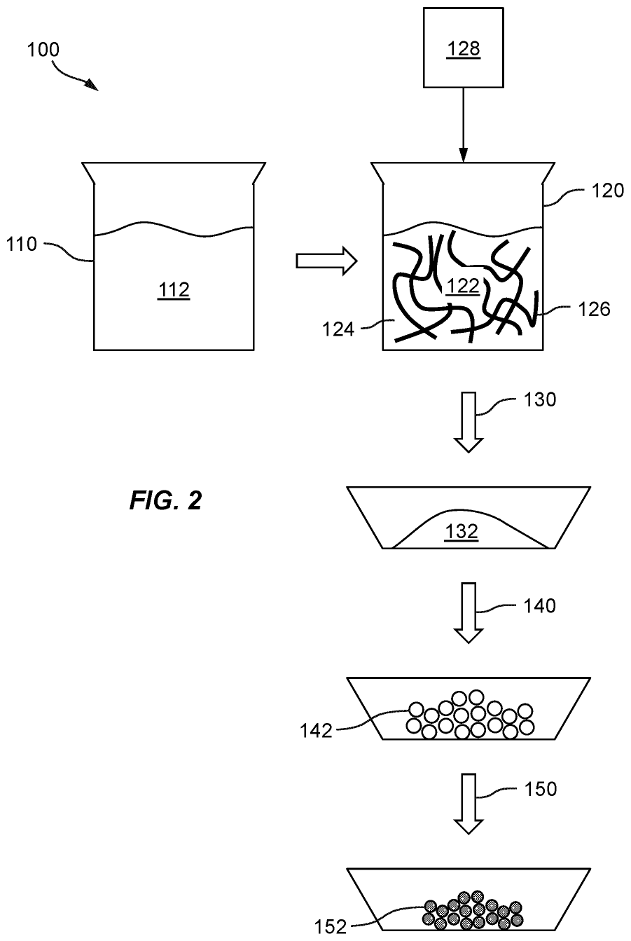

Referring now to FIG. 2, the HVD-LMR electroactive material of formula (1) may be prepared by a sol-gel process 100, which may include one or more of the following steps.

A first step 110 may comprise preparing an aqueous precursor solution 112 comprising a lithium salt, a manganese salt, a nickel salt, a compound comprising a high-valent dopant (HVD-containing compound), and a chelating agent in a solvent. The solvent may comprise water. The lithium salt, manganese salt, nickel salt, and the HVD-containing compound may be the source of the Li, Mn, Ni, and HVD in the HVD-LMR electroactive material of formula (1). The respective amounts of Li, Mn, Ni, and HVD in the precursor solution may be selected such that the ratio of the Li, Mn, Ni, and HVD in the precursor solution is substantially the same as the ratio of the Li, Mn, Ni, and HVD in the HVD-LMR electroactive material of formula (1). In some aspects, the amount of Li in the precursor solution may be selected such that the precursor solution comprises an excess amount of Li, as compared to the amount of Li in the HVD-LMR electroactive material of formula (1). For example, in comparison to the amount of Li in the HVD-LMR electroactive material of formula (1), the precursor solution may comprise, on an atomic basis, greater than or equal to 1% and less than or equal to 20%, or optionally 10%, excess Li. In one specific example, the precursor solution may comprise, on an atomic basis, 5% excess Li.

The lithium salt, manganese salt, and nickel salt may be in the form of carbonates (—[CO₃]²⁻), nitrates (—[NO₂]⁻), sulfates (—[SO₄]²⁻), hydroxides (—OH⁻), acetates (CH₃COO⁻), oxalates (C₂O₄²⁻), or a combination thereof. In aspects, one or more of the lithium salt, manganese salt, and nickel salt may be in hydrate form. Examples of lithium salts include lithium acetate (CH₃COOLi, e.g., lithium acetate dihydrate, CH₃COOLi·2H₂O), lithium nitrate (LiNO₃), lithium carbonate (Li₂CO₃), lithium sulfate (Li₂SO₄), lithium hydroxide (LiOH), lithium oxalate (Li₂C₂O₄), and combinations thereof. Examples of manganese salts include manganese carbonate (MnCO₃), manganese nitrate (Mn(NO₃)₂), manganese sulfate (MnSO₄), manganese sulfate tetrahydrate (MnSO₄·4H₂O), manganese(II) acetate (e.g., Mn(CH₃CO₂)₂·(H₂O)ₙ, where n=0, 2, or 4), manganese oxalate (MnC₂O₄), and combinations thereof. Examples of nickel salts include nickel carbonate (MnCO₃), nickel nitrate (Ni(NO₃)₂), nickel sulfate (NiSO₄), nickel sulfate hexahydrate (NiSO₄·6H₂O), nickel(II) acetate (e.g., Ni(CH₃CO₂)₂·(H₂O)ₙ, where n=0, 2, or 4), nickel oxalate (NiC₂O₄), and combinations thereof. The HVD-containing compound comprises at least one of hexavalent molybdenum Mo(VI), hexavalent tungsten W(VI), or pentavalent niobium Nb(V).

The HVD-containing compound may be in the form of an ammonium compound, a hydrate, an oxalate, an oxide, a nitrate, or a combination thereof.

Examples of HVD-containing compounds include ammonium molybdate (e.g., ammonium orthomolybdate, (NH₄)₂MoO₄, and/or ammonium heptamolybdate, (NH₄)₆Mo₇O₂₄), molybdenum(VI) oxide (MoO₃), molybdenum(VI) nitrate (Mo(NO₃)₂), molybdenum(VI) oxalate, ammonium niobate(V) oxalate hydrate (NH₄[NbO(C₂O₄)₂(H₂O)₂]·xH₂O), niobium(V) oxide (Nb₂O₅), niobium(V) nitrate (Nb(NO₃)₅), niobium(V) oxynitrate (NbO(NO₃)₃), ammonium tungstate(VI) ((NH₄)₁₀(H₂W₁₂O₄₂)·4H₂O), tungsten(VI) oxide (WO₃), tungsten(VI) nitrate (W(NO₃)₆), tungsten(VI) oxalate, and combinations thereof.

The chelating agent may comprise glycolic acid, lactic acid, gluconic acid, citric acid, ethylenediaminetetraacetic acid (EDTA), or a combination thereof. In aspects, the chelating agent comprises citric acid.

In a second step 120, the pH of the precursor solution may be controlled and/or adjusted such that the precursor solution is transformed into a gel 122 comprising a liquid phase 124 and a solid precipitate phase 126. For example, the pH of the precursor solution may be controlled and/or adjusted so that the precursor solution has a pH of greater than or equal to about 7 and less than or equal to about 9, or optionally about 8. In aspects, the pH of the precursor solution may be controlled and/or adjusted so that the precursor solution has a pH of about 7. The pH of the precursor solution may be controlled and/or adjusted, for example, by addition of a thermally labile base 128, which may be in the form of a solution comprising a base dissolved in a solvent (e.g., water). Examples of bases include sodium hydroxide (NaOH) and ammonium hydroxide (NH₄OH). The second step 120 may be performed at a temperature of about 60° C. to 90° C. with stirring for a duration of 1 hour to 12 hours.

In a third step 130, the liquid phase 124 is removed from the solid precipitate phase 126 to form a dried gel 132, for example, by evaporation. Evaporation of the liquid phase 124 may be performed by heating the gel 126 at a temperature in a range of 100 degrees Celsius to 200 degrees Celsius for 1 hour to 24 hours to form the dried gel 132. Heating the gel 126 during the third step 130 may release gaseous reaction products of H₂O and/or NH₃ therefrom.

In a fourth step 140, the dried gel 132 is annealed to remove organic compounds therefrom and form an amorphous powder 142. The dried gel 132 may be annealed by heating the dried gel 132 at a temperature in a range of 400 degrees Celsius to 600 degrees Celsius for 1 hour to 6 hours to form the amorphous powder 142. Annealing the dried gel 132 in the fourth step 140 may release gaseous products of acetic acid (CH₃COOH), acetone ((CH₃)₂CO), H₂O, and/or CO₂.

In a fifth step 150, the amorphous powder 142 is calcined to form the HVD-LMR electroactive material of formula (1) 152. Calcination of the amorphous powder 142 is performed to obtain the layered crystalline structure of the LMR electroactive material of formula (1) 152. The amorphous powder 142 may be calcined by heating the mixture in an oxygen-containing environment (e.g., air) at a temperature of about 700° C. to about 1000° C. for a duration of about 12 hours to about 36 hours. During calcination of the amorphous powder 142, gaseous reaction byproducts of oxygen (O₂) and/or carbon dioxide (CO₂) may be released therefrom. In some aspects, the amorphous powder 142 may be calcined in a step-wise manner. For example, the amorphous powder 142 may be calcined by heating the powder 142 from ambient temperature (e.g., about 25° C.) to a temperature of about 500° C. at a ramp rate of about 2° C. per minute (about 4 hours), heating the powder 142 to a temperature of about 900° C. at a ramp rate of about 2° C. per minute (about 3 hours), and then maintaining the powder 142 at a temperature of about 900° C. for about 12 hours. As another example, the powder 142 may be calcined by heating the powder 142 from ambient temperature to a temperature of about 500° C. at a ramp rate of about 2° C. per minute (about 4 hours), heating the powder 142 to a temperature of about 700° C. at a ramp rate of about 2° C. per minute (about 1.5 hours), heating the powder 142 to a temperature of about 900° C. at a ramp rate of about 2° C. per minute (about 1.5 hours), and then maintaining the powder 142 at a temperature of about 900° C. for about 12 hours.

### EXPERIMENTAL

### Example 1

Samples of layered lithium- and manganese-rich oxides (LMR) were prepared by a sol-gel method and the physical characteristics thereof were evaluated using high-energy X-ray diffraction analysis, scanning electron micrography, and inductively coupled plasma mass spectrometry (ICP-MS). The samples were prepared from aqueous precursor solutions comprising lithium acetate dihydrate, manganese acetate tetrahydrate, nickel acetate hydrate, and citric acid. Some of the samples were doped with a high-valent dopant (i.e., Mo, W, or Nb) by addition of ammonium molybdate, ammonium tungstate, or ammonium Niobate oxalate hydrate thereto. An ammonium hydroxide solution was added dropwise to the precursor solutions to maintain a pH of about 7 and form a gel, which was dried, annealed at 500° C. for 4 hours in air, and calcined at 900° C. for 15 hours in air to form the LMR samples.

The atomic ratios of Li, Mn, Ni, and the high-valent dopant in the precursor solutions and in the final LMR samples after calcination (as determined by inductively coupled plasma mass spectrometry) are shown in Table 1.

TABLE 1

| | | | 1 at % Mo | 1 at % W | 1 at % Nb | 0.25 at % Mo | 0.5 at % Mo |
|---|---|---|---|---|---|---|---|
| | | LMR | doped LMR | doped LMR | doped LMR | doped LMR | doped LMR |
| | | Atomic Ratios | | | | | |
| Ratios in | Li | 1.167 | 1.167 | 1.167 | 1.167 | 1.167 | 1.167 |
| Precursor | Mn | 0.583 | 0.575 | 0.575 | 0.575 | 0.582 | 0.581 |
| Solution | Ni | 0.250 | 0.245 | 0.245 | 0.245 | 0.249 | 0.248 |
| | Dopant | 0.000 | 0.010 | 0.010 | 0.010 | 0.003 | 0.005 |
| Actual Ratios | Li | 1.235 | 1.233 | 1.234 | 1.242 | 1.234 | 1.236 |
| Determined by | Mn | 0.583 | 0.579 | 0.579 | 0.576 | 0.584 | 0.579 |
| Inductively | Ni | 0.182 | 0.177 | 0.176 | 0.175 | 0.179 | 0.180 |
| Coupled | Dopant | 0.000 | 0.011 | 0.010 | 0.007 | 0.003 | 0.006 |
| Plasma Mass | | | | | | | |
| Spectrometry | | | | | | | |

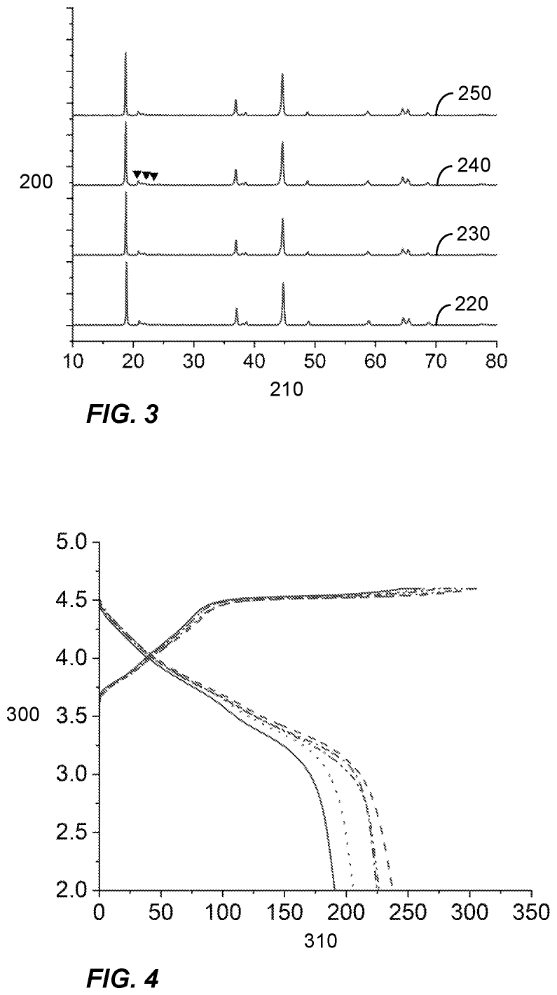

FIG. 3 is a plot of Normalized Intensity, arbitrary units, (200) vs. the Angle, 2Θ_{CuKα} (210) depicting the X-ray diffraction patterns of samples of undoped-LMR (220), 1 at % Mo-doped LMR (230), 1 at % W-doped LMR (240), and 1 at % Nb-doped LMR (250).

### Example 2

The electrochemical performance of the LMR samples prepared in Example 1 was evaluated by assembling half cells including the LMR samples as the working electrodes and Li metal as counter electrode. The working electrodes included a mixture of particles of one of the LMR samples, carbon black (CB), and PVDF (LMR:CB:PVDF mass ratio of 80:10:10). The half cells included an electrolyte of 1.2 Molar LiPF₆ in a mixture of FEC and DMC (FEC:DMC volumetric ratio of 1:4) with 1 vol. % LiPO₂F₂. Cyclic voltammetry testing was performed on the half cells by cycling the half cells at a C/20 rate for the first two cycles, and then cycling at a C/3 rate between 2.0V and 4.6V vs. Li/Li⁺ for 80-100 cycles.

FIG. 4 is a plot of Potential vs. Li/Li⁺ (300) versus Specific Capacity, mAh/g, (310) depicting charging voltage and discharging voltage for the first formation cycle for half cells including samples of undoped-LMR (solid line), 0.25 at % Mo-doped LMR (dashed line), 1 at % Mo-doped LMR (dotted line), 1 at % W-doped LMR (dash-dot-dot line), and 1 at % Nb-doped LMR (dash-dot-dash line). The first cycle coulombic efficiencies were determined as follows: undoped-LMR=72%, 0.25 at % Mo-doped LMR=76.37%, 1 at % Mo-doped LMR=73.5%, 1 at % W-doped LMR=74.66%, and 1 at % Nb-doped LMR=77.69%.

As compared to half cells including the undoped LMR, the half cells including the HVD-LMR samples exhibited higher coulombic efficiencies (2% to 5% increase over half cell including the undoped LMR) and higher specific capacities (15% to 30% increase over half cell including the undoped LMR).

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing example embodiments only and is not intended to be limiting. As used herein, the singular forms (“a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended terms “comprises,” “comprising,” “including,” and “having,” are to be understood as non-restrictive terms used to describe and claim various embodiments set forth herein, in certain aspects, the terms may alternatively be understood to instead be a more limiting and restrictive term, such as “consisting of” or “consisting essentially of.” Thus, for any given embodiment reciting compositions, materials, components, elements, ingredients, features, integers, operations, and/or process steps, the present disclosure also specifically includes embodiments consisting of, or consisting essentially of, such recited compositions, materials, components, elements, ingredients, features, integers, operations, and/or process steps. In the case of “consisting of,” the alternative embodiment excludes any additional compositions, materials, components, elements, ingredients, features, integers, operations, and/or process steps, while in the case of “consisting essentially of,” any additional compositions, materials, components, elements, ingredients, features, integers, operations, and/or process steps that materially affect the basic and novel characteristics are excluded from such an embodiment, but any compositions, materials, components, elements, ingredients, features, integers, operations, and/or process steps that do not materially affect the basic and novel characteristics can be included in the embodiment.

Any method steps, processes, and operations described herein are not to be construed as necessarily requiring their performance in the order discussed or illustrated, unless specifically identified as an order of performance. It is also to be understood that additional or alternative steps may be employed, unless otherwise indicated.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Throughout this disclosure, the numerical values represent approximate measures or limits to ranges and encompass minor deviations from the given values and embodiments, having about the value mentioned as well as those having exactly the value mentioned. Other than the working examples provided at the end of the detailed description, all numerical values of parameters (e.g., of quantities or conditions) in this specification are to be understood as being modified in all instances by the term “about” whether or not “about” actually appears before the numerical value. Numerical values of parameters in the appended claims are to be understood as being modified by the term “about” only when such term appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%. In addition, disclosure of ranges includes disclosure of all values and further divided ranges within the entire range, including endpoints and sub-ranges given for the ranges.

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated. An “X-based” composition or material broadly refers to compositions or materials in which “X” is the single largest constituent of the composition or material on a weight percentage (%) basis. This may include compositions or materials having, by weight, greater than 50% X, as well as those having, by weight, less than 50% X, so long as X is the single largest constituent of the composition or material based upon its overall weight. When a composition or material is referred to as being “substantially free” of a substance, the composition or material may comprise, by weight, less than 5%, optionally less than 3%, optionally less than 1%, or optionally less than 0.1% of the substance.

As used herein, the term “metal” may refer to a pure elemental metal or to an alloy of an elemental metal and one or more other metal or nonmetal elements (referred to as “alloying” elements). The alloying elements may be selected to impart certain desirable properties to the alloy that are not exhibited by the base metal element.

What is claimed is:

1. A positive electrode material comprising:
a layered lithium- and manganese-rich oxide represented by the formula (1):
Li₁₊ₐNi_{b}Mn_{c}Me_{d}O₂, (1)
where 0.1≤a≤0.3, 0.1≤b≤0.5, 0.4≤c≤0.7, 0.002≤d≤0.04, and Me represents a transition metal having five or more valence electrons.

2. The positive electrode material of claim 1, wherein the transition metal having five or more valence electrons is hexavalent molybdenum Mo(VI), hexavalent tungsten W(VI), pentavalent niobium Nb(V), or a combination thereof.

3. The positive electrode material of claim 1, wherein 0.15≤a≤0.25, 0.2≤b≤0.3, 0.5≤c≤0.6, and 0.005≤d≤0.025.

4. The positive electrode material of claim 1, wherein a ratio of (1+a) to (b+c+d) is greater than or equal to 1.4 and less than or equal to 1.7.

5. The positive electrode material of claim 1, wherein a ratio of c to b is greater than or equal to 1 and less than or equal to 5.

6. The positive electrode material of claim 1, wherein the oxide has a layered crystal structure including a transition metal layer, an oxygen layer, and a lithium layer, and wherein the transition metal having five or more valence electrons is present at an octahedral site within the transition metal layer.

7. A method of manufacturing a positive electrode material, the method comprising:
(a) preparing a precursor solution comprising a lithium salt, a manganese salt, a nickel salt, a compound comprising a transition metal having five or more valence electrons, and a chelating agent in a solvent;
(b) controlling or adjusting a pH of the precursor solution to form a gel comprising a liquid phase and a solid precipitate phase;
(c) removing the liquid phase from the solid precipitate phase to form a dried gel;
(d) heating the dried gel in an oxygen-containing environment to form a layered lithium- and manganese-rich oxide represented by the formula (1):
Li₁₊ₐNi_{b}Mn_{c}Me_{d}O₂, (1)
where 0.1≤a≤0.3, 0.1≤b≤0.5, 0.4≤c≤0.7, 0.002≤d≤0.04, and Me represents the transition metal having five or more valence electrons.

8. The method of claim 7, wherein the transition metal having five or more valence electrons comprises hexavalent molybdenum Mo(VI), hexavalent tungsten W(VI), pentavalent niobium Nb(V), or a combination thereof.

9. The method of claim 7, wherein the lithium salt, the manganese salt, and the nickel salt comprise carbonates, nitrates, sulfates, hydroxides, acetates, or a combination thereof.

10. The method of claim 7, wherein the lithium salt comprises lithium acetate, the manganese salt comprises manganese acetate, and the nickel salt comprises nickel acetate.

11. The method of claim 8, wherein the compound comprising the transition metal having five or more valence electrons comprises an ammonium compound, a hydrate, an oxalate, an oxide, a nitrate, or a combination thereof.

12. The method of claim 7, wherein the chelating agent comprises citric acid.

13. The method of claim 7, wherein the solvent comprises water.

14. The method of claim 7, wherein controlling or adjusting the pH of the precursor solution in step (b) comprises:
introducing a base into the precursor solution such that the precursor solution has a pH of about 7.

15. The method of claim 7, wherein the precursor solution comprises a stoichiometric excess of lithium, and wherein a molar ratio of lithium to the combined amount of manganese, nickel, and the transition metal having five or more valence electrons [Li/(Mn+Ni+Me)] in the precursor solution is greater than or equal to 1.4 and less than or equal to 1.7.

16. The method of claim 7, wherein a molar ratio of Mn to Ni in the precursor solution is greater than or equal to 1 and less than or equal to 5.

17. The method of claim 7, wherein step (c) comprises:
heating the gel at a temperature in a range of 100 degrees Celsius to 200 degrees Celsius such that gaseous reaction products of H₂O and/or NH₃ are released therefrom.

18. The method of claim 7, wherein step (d) comprises:
heating the dried gel at a temperature in a range of 400 degrees Celsius to 600 degrees Celsius to form a powder having an amorphous structure; and then
calcining the powder by heating the powder in an oxygen-containing environment at a temperature of about 700 degrees Celsius to about 1000 degrees Celsius to form the layered lithium- and manganese-rich oxide represented by the formula (1).

19. The method of claim 18, wherein, after the powder is calcined, the layered lithium- and manganese-rich oxide represented by the formula (1) has a layered crystal structure including a transition metal layer, an oxygen layer, and a lithium layer, and wherein the transition metal having five or more valence electrons is present at an octahedral site within the transition metal layer.

20. The method of claim 7, further comprising:
mixing particles of the layered lithium- and manganese-rich oxide represented by the formula (1) with particles of an electrically conductive material and a polymer binder.
